(19) United States
(12) Patent Application Publication
(10) Pub. No.: US 2026/0249757 A1
(43) Pub. Date: Aug. 27, 2026

(54) VEHICLE SEAT

(71) Applicant: TOYOTA BOSHOKU KABUSHIKI KAISHA, Aichi (JP)

(72) Inventor: Koji KIMURA, Seto-shi (JP)

(73) Assignee: TOYOTA BOSHOKU KABUSHIKI KAISHA, Aichi (JP)

(21) Appl. No.: 19/541,894

(22) Filed: Feb. 17, 2026

(30) Foreign Application Priority Data
Feb. 25, 2025 (JP) 2025-027987

(51) Int. Cl. B60N 2/427; B60N 2/42

(52) U.S. Cl. CPC B60N 2/42754; B60N 2/4221; B60N 2/42781

(57) ABSTRACT

One aspect of the present disclosure provides a vehicle seat including a fixed frame, a seat cushion, a first link, a second link, a driving body, and a coupling device. The coupling device is configured (i) to couple the second link with the driving body for a relaxation position of the seat cushion and (ii) to release the coupling between the second link and the driving body in response to an acceleration in a seat forward direction exceeding a predetermined magnitude.

### CROSS-REFERENCE TO RELATED APPLICATIONS

The present application claims the benefit of Japanese Patent Application No. 2025-027987 filed on February 25, 2025 with the Japan Patent Office, the entire disclosure of which is incorporated herein by reference.

### BACKGROUND

The present disclosure relates to a vehicle seat capable of assuming a relaxation position.

As disclosed in Japanese Unexamined Patent Application Publication No. 2023-155787, upon occurrence of a frontal collision during the relaxation position, a significant load may act on the lumbar region or the like of an occupant.

### SUMMARY

In one aspect of the present disclosure, it is desirable to provide a vehicle seat capable of suppressing a significant load from acting on the lumbar region or the like of an occupant even in the event of a frontal collision while the vehicle seat is in the relaxation position.

One aspect of the present disclosure provides a vehicle seat including a fixed frame, a seat cushion, a first link, a second link, a driving body, and a coupling device.

The fixed frame is configured to be fixed to a vehicle. The seat cushion includes a front end portion and a rear end portion and is configured to be displaced between (i) a relaxation position in which the front end portion is at a higher position than the rear end portion and (ii) a normal position in which a height difference between the front end portion and the rear end portion is smaller than that in the relaxation position. The first link comprises a first end portion and a second end portion, the first end portion being rotatably coupled to the front end portion of the seat cushion. The second link comprises a third end portion and a fourth end portion, the third end portion being rotatably coupled to the second end portion of the first link, and the fourth end portion being rotatably coupled to the fixed frame. The driving body is rotatably coupled to the fixed frame and is configured to rotate by receiving torque from an electric motor. The coupling device is configured (i) to couple the second link with the driving body for the relaxation position and (ii) to release the coupling between the second link and the driving body in response to an acceleration in a seat forward direction exceeding a predetermined magnitude.

In such a vehicle seat, when a large acceleration in the seat forward direction occurs during the relaxation position, the coupling between the second link and the driving body is released, and the vehicle seat returns from the relaxation position to the normal position.

Therefore, the vehicle seat can immediately return from the relaxation position to the normal position when a frontal collision or the like occurs. As a result, it is possible to suppress a significant load from acting on the lumbar region or the like of an occupant.

The coupling device may comprise a coupling pin, a locking member, and a spring. One of the driving body and the second link may be a first member. The remaining one of the driving body and the second link may be a second member. The first member may define an elongated slot having a fifth end portion and a sixth end portion in a longitudinal direction of the elongated slot. The second member may be provided with the coupling pin passing through the elongated slot. The locking member may be provided on the first member so as to be displaceable between (i) an engagement position where the locking member is engaged with the coupling pin and (ii) a release position where the locking member is disengaged from the coupling pin. The spring may be configured to apply a biasing force to the locking member to hold the locking member in the engagement position.

The driving body and the second link may be configured to interlock with each other in a state where the coupling pin is positioned at the fifth end portion and the coupling pin is engaged with the locking member.

When projected onto a virtual plane perpendicular to a seat width direction, a first coupling center, which is a coupling center between the fourth end portion of the second link and the fixed frame, may coincide with a second coupling center, which is a coupling center between the driving body and the fixed frame. The elongated slot may be curved in an arcuate shape centered on the second coupling center. A contact portion may be inclined relative to a reference line and a virtual line perpendicular to the reference line.

With such a configuration, it may be possible to reliably release the engagement between the coupling pin and the locking member when a large acceleration in the seat forward direction occurs during the relaxation position.

The contact portion is a portion of the locking member that is in contact with the coupling pin in a state where the coupling pin is positioned at the fifth end portion of the elongated slot and the coupling pin is engaged with the locking member.

The reference line is a virtual line passing through the second coupling center and a center of the coupling pin in a state where the coupling pin is positioned at the fifth end portion.

The locking member may comprise a rebound restriction portion configured to engage with the coupling pin positioned at the sixth end portion of the elongated slot and to restrict the coupling pin from being displaced toward the fifth end portion.

According to such a configuration, it is possible to suppress the seat cushion, which has returned to the normal position, from being displaced to the relaxation position again.

The vehicle seat may comprise an absorption portion configured to absorb at least a part of kinetic energy of the seat cushion when the coupling between the second link and the driving body is released and the front end portion of the seat cushion falls. Such an absorption portion can mitigate an impact when the seat cushion falls.

The absorption portion may be provided on the fixed frame.

The absorption portion may be configured to be displaced in interlock with the driving body. The absorption portion may be provided so as to be (i) at a position capable of colliding with the seat cushion when the seat cushion falls during the relaxation position and (ii) at a position deviated from the position capable of colliding during the normal position.

The absorption portion may be provided on the seat cushion. The vehicle seat may comprise an interference portion configured to collide with the absorption portion when the seat cushion falls. The interference portion may be arranged so as to be (i) at a position capable of colliding with the absorption portion when the seat cushion falls during the relaxation position and (ii) at a position deviated from the position capable of colliding during the normal position.

The absorption portion may be provided on the seat cushion as a weakened portion configured to induce deformation of the seat cushion. The vehicle seat may comprise an interference portion configured to collide with the seat cushion when the seat cushion falls. The interference portion may be arranged so as to be (i) at a position capable of colliding with the seat cushion when the seat cushion falls during the relaxation position and (ii) at a position deviated from the position capable of colliding during the normal position.

The first member may comprise a resistance portion configured to resist displacement of the coupling pin when the coupling pin is displaced toward the sixth end portion of the elongated slot.

### BRIEF DESCRIPTION OF THE DRAWINGS

Example embodiments of the present disclosure will be described hereinafter with reference to the accompanying drawings, in which:

FIG. 1 shows a vehicle seat according to a first embodiment;

FIG. 2 shows the vehicle seat according to the first embodiment;

FIG. 3 shows a coupling device according to the first embodiment;

FIG. 4 shows the coupling device according to the first embodiment;

FIG. 5 shows a structure of the coupling device according to the first embodiment;

FIG. 6 shows the coupling device according to the first embodiment;

FIG. 7 shows the coupling device according to the first embodiment;

FIG. 8 shows the coupling device according to the first embodiment;

FIG. 9 shows the coupling device according to the first embodiment;

FIG. 10 shows a normal position of the vehicle seat according to the first embodiment;

FIG. 11 shows a relaxation position of the vehicle seat according to the first embodiment;

FIG. 12 shows a coupling device according to a second embodiment;

FIG. 13 shows the coupling device according to the second embodiment;

FIG. 14 shows the coupling device according to the second embodiment;

FIG. 15 shows a coupling device according to a third embodiment;

FIG. 16 shows the coupling device according to the third embodiment;

FIG. 17 shows a coupling device according to a fourth embodiment;

FIG. 18A and FIG. 18B each show a sector gear according to a fifth embodiment; and

FIG. 19 shows a coupling device according to one variation.

### DETAILED DESCRIPTION OF EXEMPLARY EMBODIMENTS

The following embodiments illustrate examples falling within the technical scope of the present disclosure. It should be understood that the present disclosure is not limited to the specific configurations, structures, or the like described in the embodiments below.

The following embodiments are non-limiting examples in which a vehicle seat of the present disclosure is applied to a rear seat to be mounted in a vehicle such as a passenger car (hereinafter referred to as a “vehicle seat”). Directional arrows, hatching, and the like in the drawings are provided to facilitate understanding of the relationships between the drawings, shapes of members or portions, and so on.

Accordingly, the vehicle seat is not limited to the orientations shown in the drawings. The directions shown in the drawings correspond to the orientations in a state where the vehicle seat according to the embodiments is mounted in the automobile. The drawings with hatching do not necessarily represent cross-sectional views.

At least one of each member or portion described with a reference numeral is provided, unless otherwise specified, such as by the term “one”. That is, unless “one” is specified, two or more of such members may be provided. The vehicle seat disclosed herein comprises at least one of the components such as the members or portions described with reference numerals, and at least one of the structural portions shown in the drawings.

### First Embodiment

### Overview of Vehicle Seat

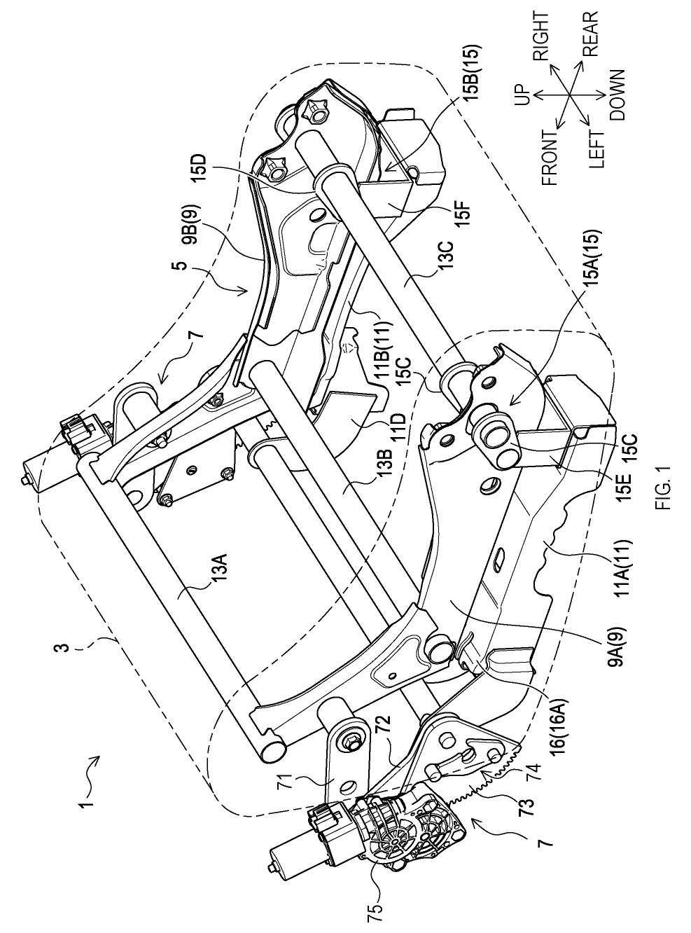

As shown in FIG. 1, a vehicle seat 1 comprises at least a seat cushion 3 and a seatback (not shown). The seat cushion 3 is configured to support an occupant’s buttocks. The seatback is configured to support the occupant’s back.

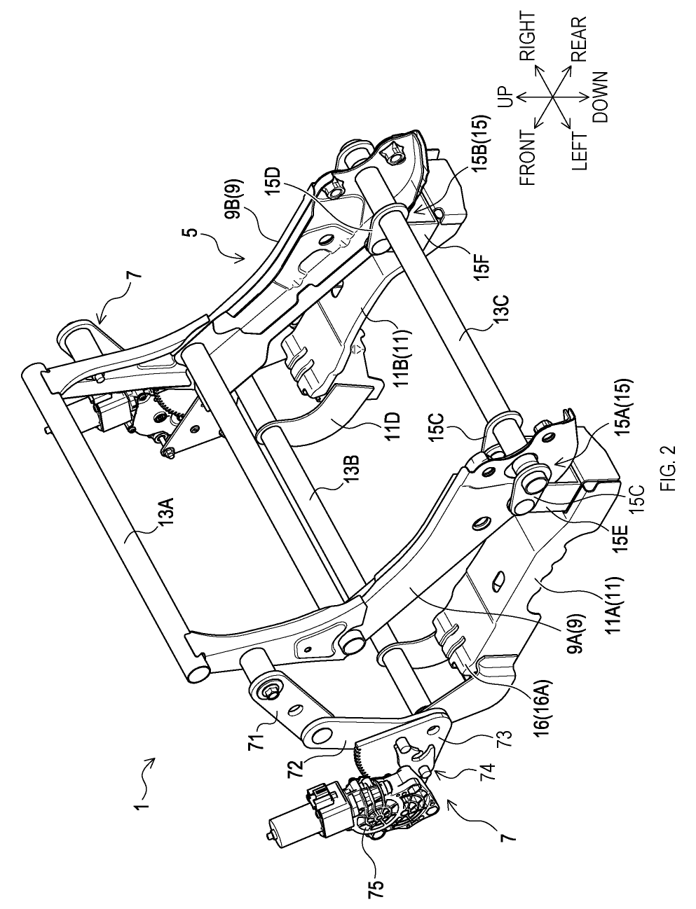

The seat cushion 3 is configured to be displaceable between a relaxation position (see FIG. 2) and a normal position (see FIG. 1). A user of the vehicle seat 1 can displace the seat cushion 3 to the relaxation position or the normal position by operating an operating portion (not shown).

In the relaxation position, a front end portion of the seat cushion 3 is disposed higher than a rear end portion thereof (see FIG. 2). In the normal position, the height difference between the front end portion and the rear end portion of the seat cushion 3 is smaller than that in the relaxation position (see FIG. 1).

As shown in FIG. 1, the seat cushion 3 is substantially laterally symmetrical. Specifically, the seat cushion 3 comprises at least a cushion frame 5 and a position-change device 7.

The cushion frame 5 comprises at least a first side frame 9A, a second side frame 9B, a first fixed frame 11A, a second fixed frame 11B, a first coupling members 13A, a second coupling member 13B, a third coupling member 13C, a first support portion 15A, and a second support portion 15B.

The first side frame 9A is a structural member forming a lower arm extending in a seat front-rear direction. The second side frame 9B is a structural member forming a lower arm disposed at a position shifted in a seat width direction relative to the first side frame 9A and extending in the seat front-rear direction.

Hereinafter the “side frame 9” refers to any one of the first side frame 9A and the second side frame 9B, or is a generic term for the first side frame 9A and the second side frame 9B.

The first fixed frame 11A and the second fixed frame 11B are structural members configured to be fixed directly or indirectly (directly in the present embodiment) to the vehicle. The first fixed frame 11A is disposed below the first side frame 9A. The second fixed frame 11B is disposed below the second side frame 9B.

Hereinafter, the “fixed frame 11” refers to any one of the first fixed frame 11A and the second fixed frame 11B, or is a generic term for the first fixed frame 11A and the second fixed frame 11B.

The first through third coupling members 13A through 13C extend in the seat width direction and couple the first side frame 9A with the second side frame 9B. The first coupling member 13A couples front end portions of the first side frames 9A. The third coupling member 13C couples rear end portions of the side frames 9. The second coupling member 13B couples intermediate portions in the extending direction of the side frames 9.

The first support portion 15A rotatably supports the rear end portion of the first side frame 9A. The second support portion 15B rotatably supports the rear end portion of the second side frame 9B. Hereinafter, the “support portion 15” refers to any one of the first support portion 15A and the second support portion 15B, or is a generic term for the first support portion 15A and the second support portion 15B.

The support portion 15 comprises a first link 15C or 15D, and a second link 15E or 15F. The lower end of each of the second links 15E and 15F is secured to the corresponding fixed frame 11.

The upper end of each of the second links 15E and 15F is coupled to the third coupling member 13C via the first link 15C or 15D. Therefore, when the front end portion of the side frame 9 is displaced in an up-down direction, the third coupling member 13C pivotally displaces about the upper ends of the second links 15E and 15F.

The position change device 7 is configured to change the position of the seat cushion 3 by displacing the upper end portion of the side frame 9 in the up-down direction. That is, when the position change device 7 activates, the upper end portion of the side frame 9 moves upward or downward, so that the seat cushion 3 transitions to the relaxation position or the normal position.

### Position Change Device

### Overview of Position Change Device

In the present embodiment, the position change device 7 is provided for each of the first side frame 9A and the second side frame 9B. The position change device 7 provided for the first side frame 9A has the same configuration as that of the position change device 7 provided for the second side frame 9B, except for being laterally symmetrical. The following description relates to the position change device 7 provided for the first side frame 9A.

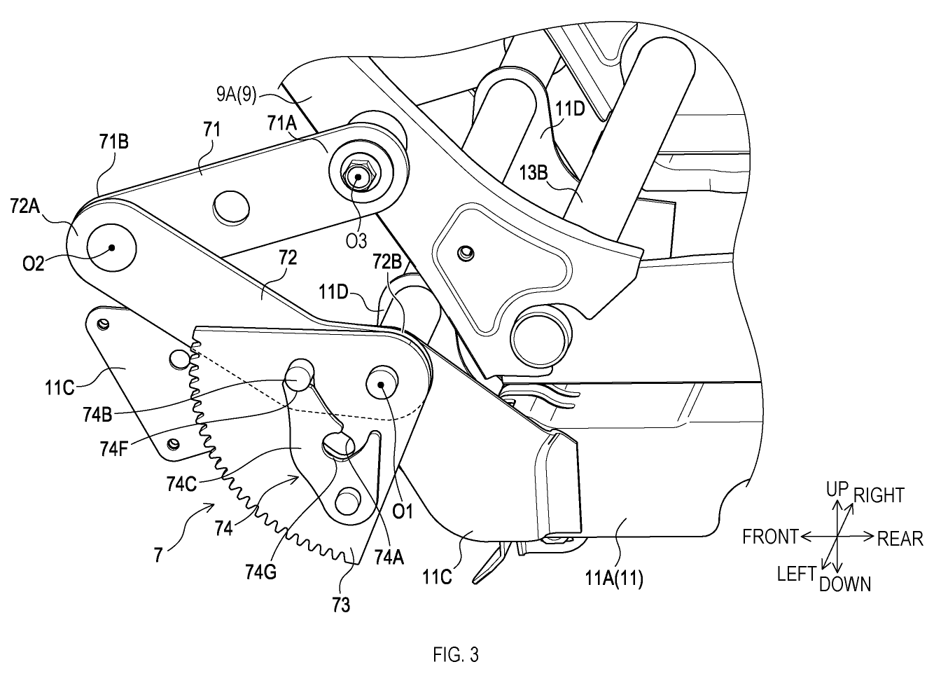

As shown in FIG. 1, the position change device 7 comprises at least a first link 71, a second link 72, a sector gear 73, a coupling device 74, and an electric motor 75. As shown in FIG. 3, the first link 71 comprises a first end portion 71A and a second end portion 71B opposite to the first end portion 71A. The first end portion 71A is rotatably coupled to a front portion of the side frame 9.

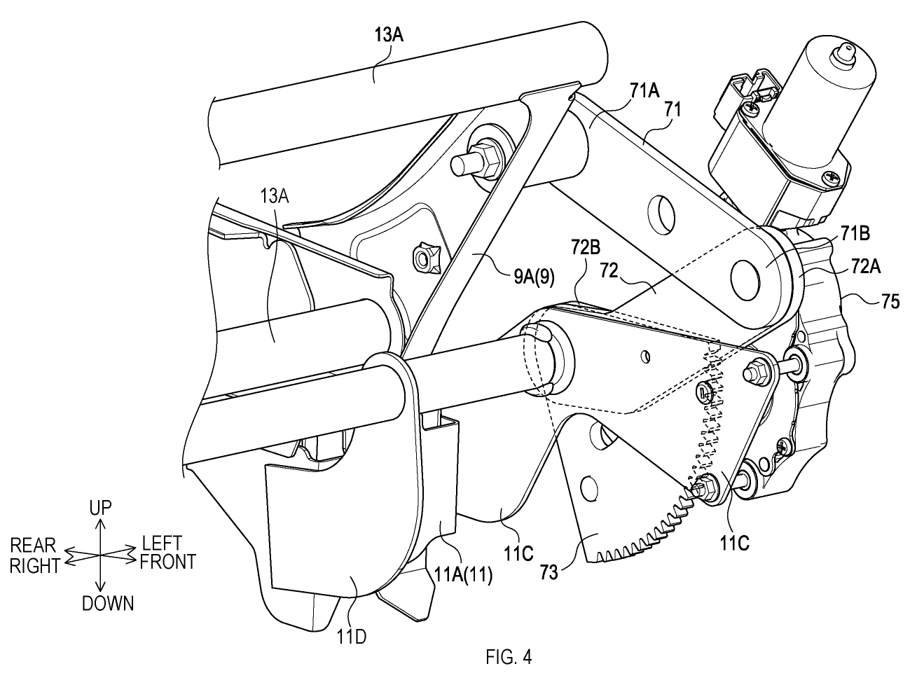

As shown in FIG. 4, the second link 72 comprises a third end portion 72A and a fourth end portion 72B opposite to the third end portion 72A. The third end portion 72A is rotatably coupled to the second end portion 71B of the first link 71. The fourth end portion 72B is rotatably coupled to the fixed frame 11 indirectly or directly.

The second link 72 according to the present embodiment is indirectly coupled to the fixed frame 11 via a fixed plate 11C. The fixed plate 11C is fixed to the front end portion of the fixed frame 11 by welding or the like, and forms a part of the fixed frame 11.

As shown in FIG. 3, in the present embodiment, at least in the normal position, the first link 71 and the second link 72 are coupled in a state of being bent in a V-shape or an L-shape such that a coupling point O2 convex toward the forward side.

The sector gear 73 is a non-limiting example of a driving body rotatably coupled to the fixed frame 11, and is configured to rotate by receiving torque from the electric motor 75. In the present embodiment, the sector gear 73 is indirectly coupled to the fixed frame 11 via the fixed plate 11C.

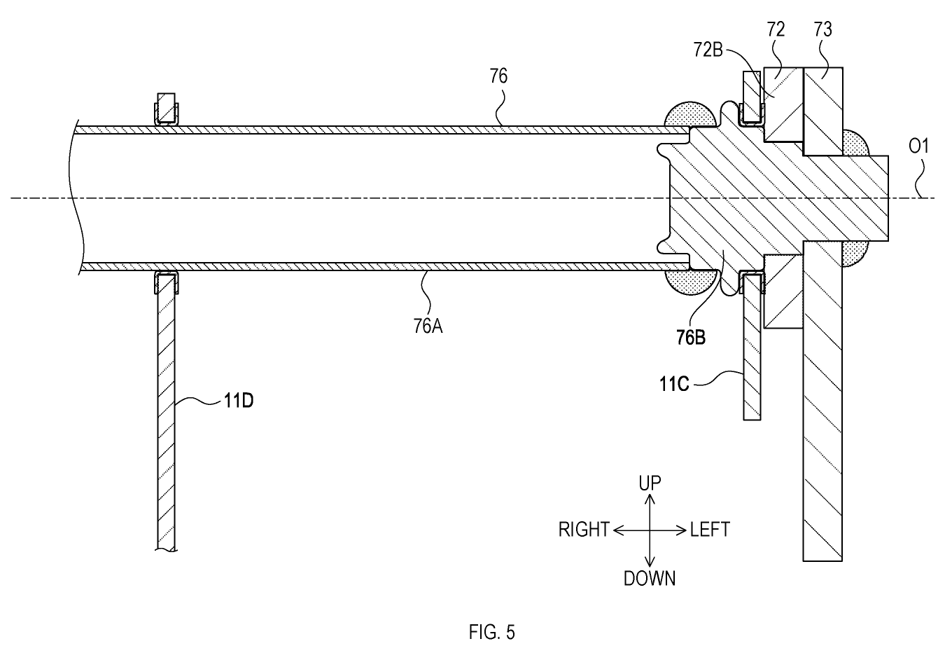

As shown in FIG. 5, in the present embodiment, the sector gear 73 and the fourth end portion 72B of the second link 72 are rotatably coupled to the fixed plate 11C via a common shaft portion 76. The shaft portion 76 is a shaft extending in the seat width direction.

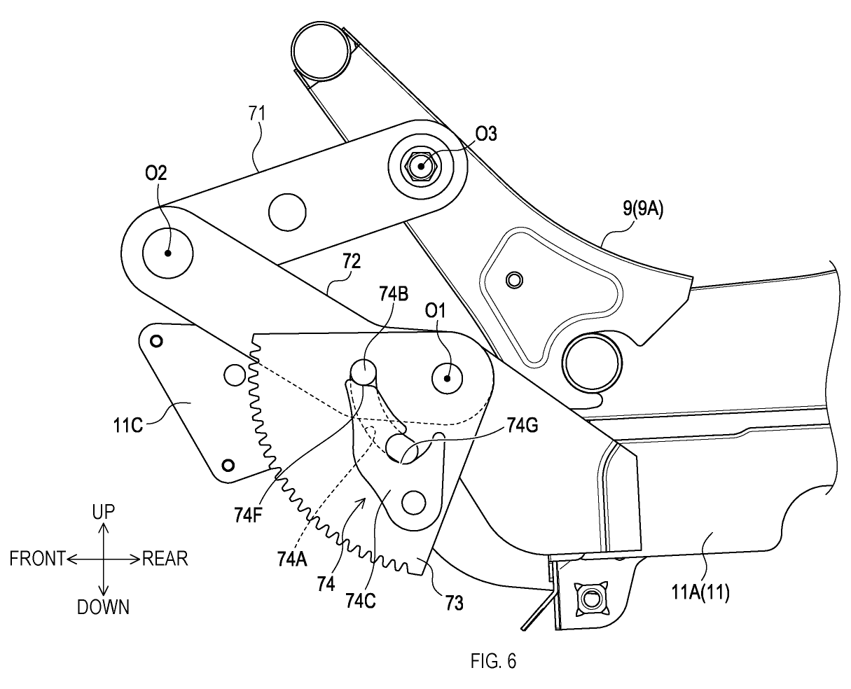

That is, as shown in FIG. 6, a coupling center between the second link 72 projected onto a virtual plane orthogonal to the seat width direction and the fixed frame 11 projected onto the virtual plane coincides with a coupling center between the sector gear 73 projected onto the virtual plane and the fixed frame 11 projected onto the virtual plane. The virtual plane corresponds to the paper surface of FIG. 6.

Hereinafter, the coupling center O1 refers to the above-mentioned coupling center, the coupling center O2 refers to the coupling center between the first link 71 and the second link 72, and the coupling center O3 refers to the coupling center between the first link 71 and the side frame 9.

The sector gear 73 is secured to the shaft portion 76. The second link 72 is rotatably coupled to the shaft portion 76. Specifically, as shown in FIG. 5, the sector gear 73 is welded to the shaft portion 76. The shaft portion 76 passes through a through hole provided in the fourth end portion 72B of the second link 72. Therefore, the second link 72 is rotatable about the shaft portion 76.

The shaft portion 76 comprises a pipe 76A extending in the seat width direction, a solid shaft body 76B, and the like. The shaft body 76B is secured to a longitudinal end portion of the pipe 76A. The shaft body 76B is rotatably supported by the fixed plate 11C.

Accordingly, as the sector gear 73 rotates, the shaft portion 76 also rotates integrally with the sector gear 73. In the present embodiment, the shaft portion 76 is rotatably supported by a support plate 11D in addition to the fixed plate 11C. The support plate 11D is secured to the fixed frame 11 (see FIG. 4).

The coupling device 74 is configured (i) to couple the second link 72 with the sector gear 73 for the relaxation position and (ii) to release the coupling between the second link 72 and the sector gear 73 in response to an acceleration in the seat forward direction exceeding a predetermined magnitude.

The electric motor 75 is configured to generate torque to be applied to the sector gear 73 (see FIG. 1). The electric motor 75 according to the present embodiment is a geared motor with an integrated speed reducer. This speed reducer comprises at least a worm and a worm wheel.

Therefore, the electric motor 75 exerts a braking function (also referred to as a “self-locking function”) when stopped. As shown in FIG. 4, the electric motor 75 is indirectly coupled to the fixed frame 11 via the fixed plate 11C.

### Details of Coupling Device

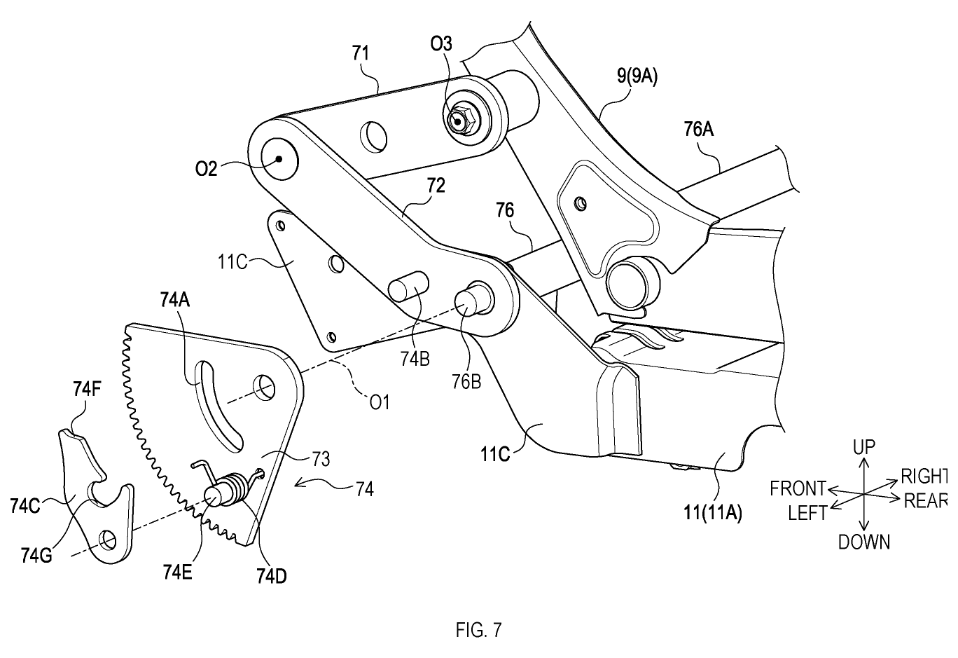

As shown in FIG. 7, the coupling device 74 comprises at least an elongated slot 74A, a coupling pin 74B, a locking member 74C, and a spring 74D.

The elongated slot 74A is provided in the sector gear 73. As shown in FIG. 6, when projected onto the virtual plane, the elongated slot 74A is curved to draw an arc centered on the coupling center O1.

The coupling pin 74B is provided on the second link 72. As shown in FIG. 3, the coupling pin 74B passes through the elongated slot 74A. The coupling pin 74B has a diameter substantially equal to the minor diameter of the elongated slot 74A.

The locking member 74C is provided on the sector gear 73. The locking member 74C is provided on the sector gear 73 so as to be displaceable between (i) a position where the locking member 74C engages with the coupling pin 74B (hereinafter referred to as an “engaged position”) and (ii) a position where the locking member 74C is disengaged from the coupling pin 74B (hereinafter referred to as a “released position”).

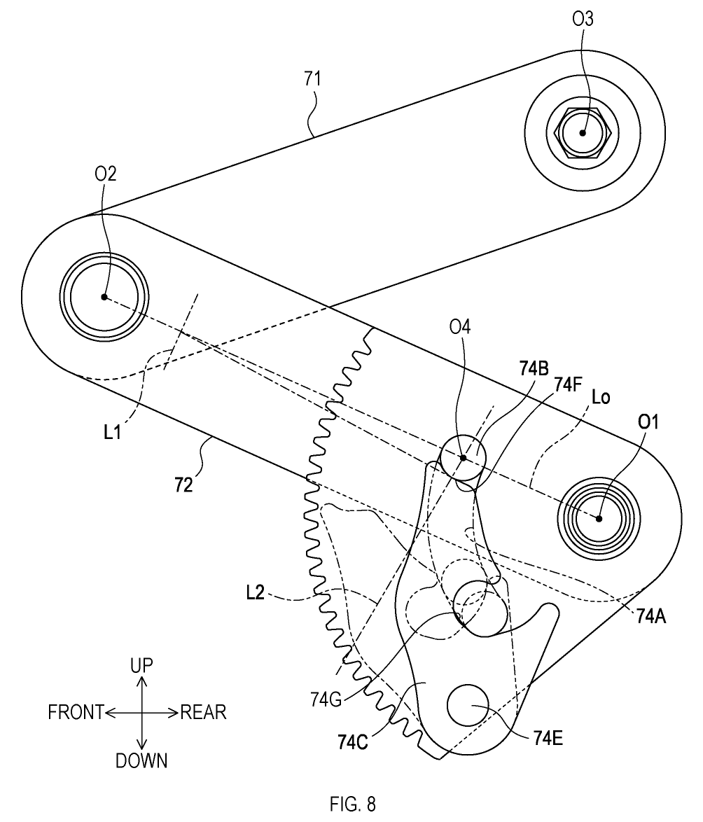

Specifically, the engaged position refers to the position indicated by the solid line in FIG. 8. The released position refers to the position indicated by the two-dot chain line in FIG. 8. That is, the locking member 74C according to the present embodiment is swingable about a shaft 74E between the engaged position and the released position.

The spring 74D is a biasing member that applies a biasing force (hereinafter referred to as a “holding force”) to the locking member 74C to hold the locking member 74C in the engaged position. The spring 74D according to the present embodiment is, for example, a torsion coil spring, and a coiled portion thereof is disposed around the shaft 74E.

The elongated slot 74A comprises a fifth end portion and a sixth end portion in its major diameter direction. In a state where the coupling pin 74B is located at the fifth end portion of the elongated slot 74A and the coupling pin 74B is engaged with the locking member 74C (see FIG. 6), the sector gear 73 and the second link 72 rotate integrally.

In FIG. 6, the fifth end portion of the elongated slot 74A corresponds to the upper end portion of the elongated slot 74A, and the sixth end portion of the elongated slot 74A corresponds to the lower end portion of the elongated slot 74A. Thus, hereinafter, the fifth end portion is also referred to as the “upper end portion”. Similarly, the sixth end portion is also referred to as the “lower end portion”.

Hereinafter, a portion of the locking member 74C that contacts the coupling pin 74B when the locking member 74C is in the engaged position (see FIG. 6) is referred to as a contact portion 74F (see FIG. 7). More specifically, the contact portion 74F is a portion of the locking member 74C that contacts the coupling pin 74B when the coupling pin 74B is located at the upper end portion of the elongated slot 74A and the coupling pin 74B is engaged with the locking member 74C.

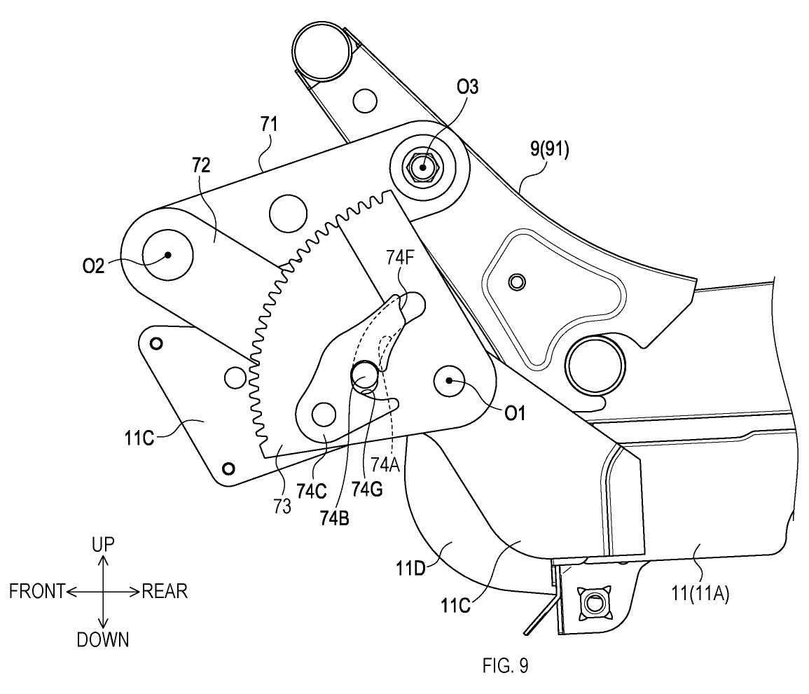

In addition to the contact portion 74F, the locking member 74C is provided with a restriction portion 74G (see FIG. 7). The restriction portion 74G is a non-limiting example of a rebound restricting portion configured to engage with the coupling pin 74B when the coupling pin 74B is located at the lower end portion of the elongated slot 74A (see FIG. 9).

When the coupling pin 74B engages with the restriction portion 74G, the coupling pin 74B located at the lower end portion of the elongated slot 74A is restricted from being displaced again toward the upper end portion of the elongated slot 74A. Therefore, the coupling pin 74B is held at the lower end portion of the elongated slot 74A, and the second link 72 and the sector gear 73 are restricted from being coupled again.

### Details of Contact Portion

As shown in FIG. 8, the contact portion 74F projected onto the virtual plane is inclined relative to the reference line Lo and the virtual line L1. The virtual line L1 is orthogonal to the reference line Lo.

The reference line Lo refers to a virtual line passing through the coupling center O1 and the center O4 in a state where the coupling pin 74B is located at the upper end portion of the elongated slot 74A. The center O4 refers to the center of the coupling pin 74B projected onto the virtual plane.

In other words, the contact portion 74F is inclined such that, when a force parallel to the virtual line L1 acts on the coupling pin 74B and the locking member 74C, a force for displacing the locking member 74C toward the released position is generated at the contact portion 74F.

The shaft 74E according to the present embodiment is disposed at a position shifted from the virtual line L2 orthogonal to the reference line Lo passing through the center O4. Accordingly, when a drag force acts on the contact portion 74F, a moment for rotating the locking member 74C toward the released position can be reliably generated.

### Absorption Portion

As shown in FIG. 1, the vehicle seat 1 according to the present embodiment is also provided with an absorption portion 16. The absorption portion 16 is configured to absorb at least a part of kinetic energy generated in the seat cushion 3.

The kinetic energy refers to kinetic energy generated when the coupling between the second link 72 and the sector gear 73 of the coupling device 74 is released and the front end portion of the seat cushion 3 falls, that is, kinetic energy generated when the seat cushion 3 changes from the relaxation position to the normal position.

The absorption portion 16 according to the present embodiment is formed by a bulging portion 16A provided on the fixed frame 11. That is, when the front end portion of the seat cushion 3 falls, the side frame 9 collides with the bulging portion 16A. As a result, the bulging portion 16A plastically deforms to absorb the kinetic energy.

### Operation of Position Change Device

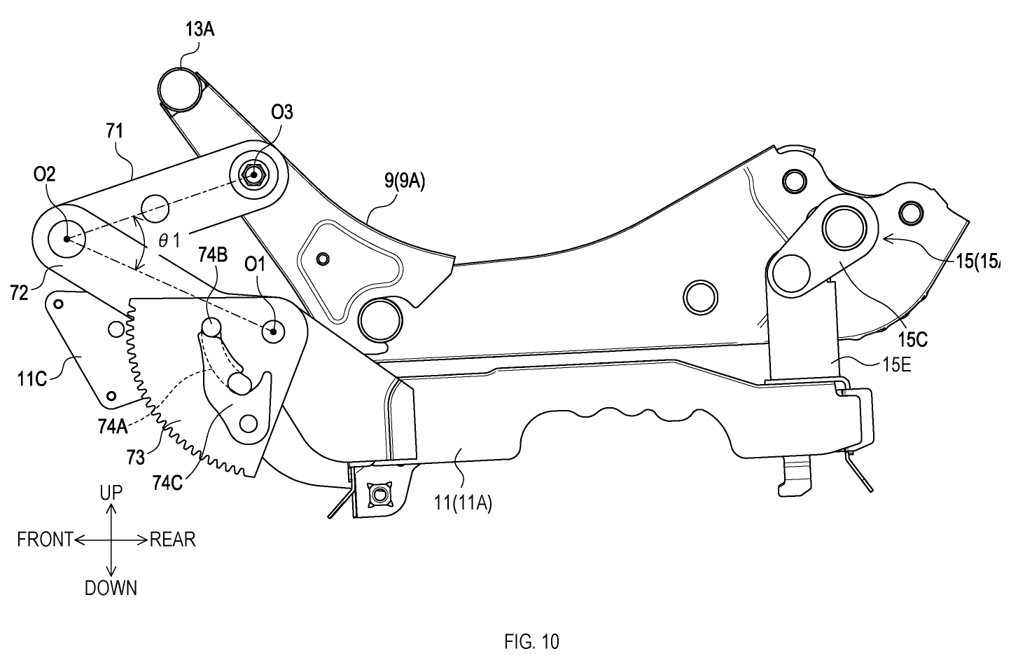

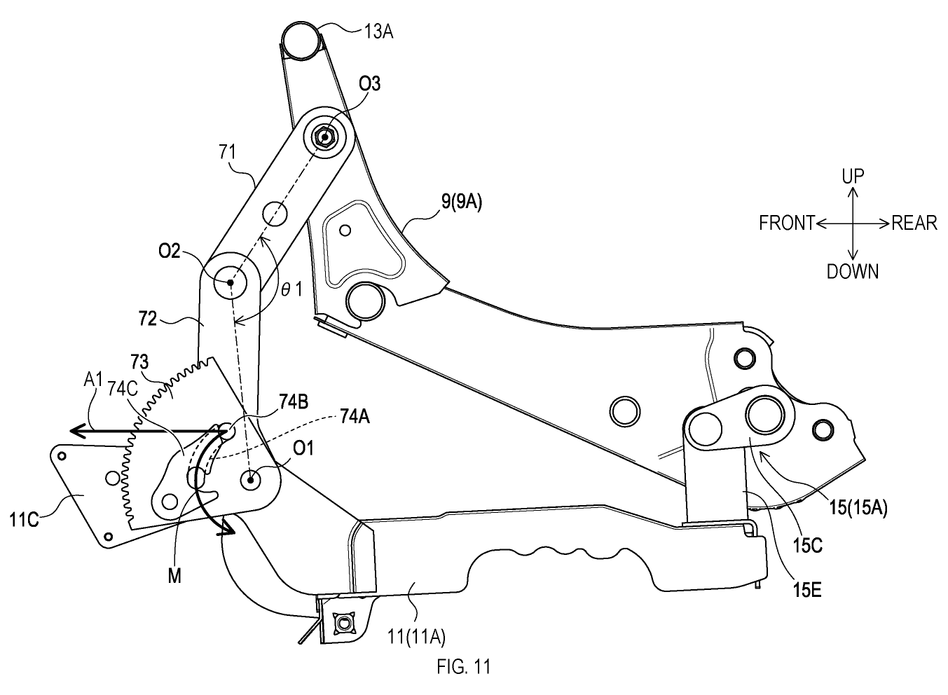

In the normal position (see FIG. 10) and the relaxation position (see FIG. 11), the coupling pin 74B is located at the upper end portion of the elongated slot 74A, and the locking member 74C is engaged with the coupling pin 74B.

An included angle θ1 in the normal position is smaller than that in the relaxation position. The included angle θ1 refers to an angle formed by the first link 71 and the second link 72. When the electric motor 75 operates during the normal position, the sector gear 73 and the second link 72 rotate integrally to expand the included angle θ1, and the seat cushion 3 assumes the relaxation position.

When an acceleration A1 in the seat forward direction (see FIG. 11) occurs during the relaxation position, the second link 72, the coupling pin 74B, and the locking member 74C are subjected to an inertial force caused by the acceleration A1 and tend to rotate forward (in the counterclockwise direction in FIG. 11) about the coupling center O1.

At this time, the inertial force generated in the coupling pin 74B and the locking member 74C applies a force for rotating the locking member 74C toward the released position (hereinafter referred to as a “release force M”) to the contact portion 74F. When the release force M exceeds the holding force of the spring 74D, the engagement between the coupling pin 74B and the locking member 74C is released.

When the engagement between the coupling pin 74B and the locking member 74C is released, the second link 72 is released from the constraint with the sector gear 73. Therefore, the second link 72 rotates downward (in the counterclockwise direction in FIG. 11) due to the load caused by the weight of the seat cushion 3 and the occupant.

At this time, the coupling pin 74B moves from the upper end portion to the lower end portion within the elongated slot 74A. When the coupling pin 74B reaches the lower end portion of the elongated slot 74A, as shown in FIG. 9, the restriction portion 74G engages with the coupling pin 74B. The force for rotating the locking member 74C toward the engaged position (in the clockwise direction in FIG. 9) is the biasing force of the spring 74D.

Even after the engagement between the coupling pin 74B and the locking member 74C is released, the sector gear 73 is held at the position corresponding to the relaxation position by the self-locking function of the electric motor 75. That is, when the engagement between the coupling pin 74B and the locking member 74C is released, only the first link 71 and the second link 72 return to their positions corresponding to the normal position (see FIG. 9).

Further, when the engagement between the coupling pin 74B and the locking member 74C is released and the front end portion of the seat cushion 3 falls, the side frame 9 collides with the bulging portion 16A, and the bulging portion 16A plastically deforms to absorb the kinetic energy.

### Features of Vehicle Seat according to Present Embodiment

In the vehicle seat 1 according to the present embodiment, when a significant acceleration in the seat forward direction occurs during the relaxation position, the coupling between the sector gear 73 and the second link 72 is released. Accordingly, the constraint of the second link 72 is released, so that the vehicle seat 1 returns from the relaxation position to the normal position.

Therefore, in the vehicle seat 1, the position (or the attitude) of the vehicle seat 1 can immediately return from the relaxation position to the normal position when a frontal collision or the like occurs. Consequently, even in the event of a frontal collision during the relaxation position, a significant load can be suppressed from acting on the lumbar region or the like of the occupant.

In the vehicle seat 1, the contact portion 74F is inclined with respect to the reference line Lo and the virtual line L1. Accordingly, when a significant acceleration in the seat forward direction occurs during the relaxation position, the engagement between the coupling pin 74B and the locking member 74C can be reliably released.

In the vehicle seat 1, after the engagement between the coupling pin 74B and the locking member 74C is released, the coupling pin 74B is restricted from being displaced toward the upper end portion of the elongated slot 74A by the restriction portion 74G. Accordingly, the vehicle seat 1 that has returned to the normal position can be suppressed from assuming the relaxation position again.

In the vehicle seat 1, the impact when the seat cushion 3 falls can be alleviated by the absorption portion 16 configured to absorb at least a part of the kinetic energy generated when the seat cushion 3 changes from the relaxation position to the normal position.

### Second Embodiment

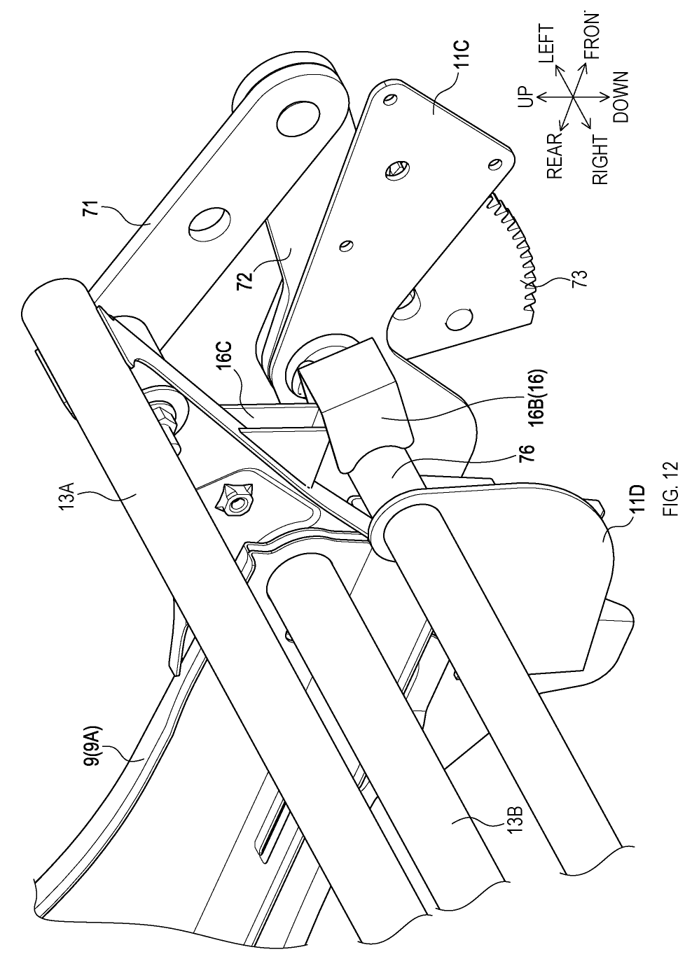

As shown in FIG. 12, in the present embodiment, the absorption portion 16 is formed by an energy absorption (EA) portion 16B. The EA portion 16B is configured to be displaced in conjunction with the sector gear 73. Specifically, the EA portion 16B is provided on the shaft portion 76.

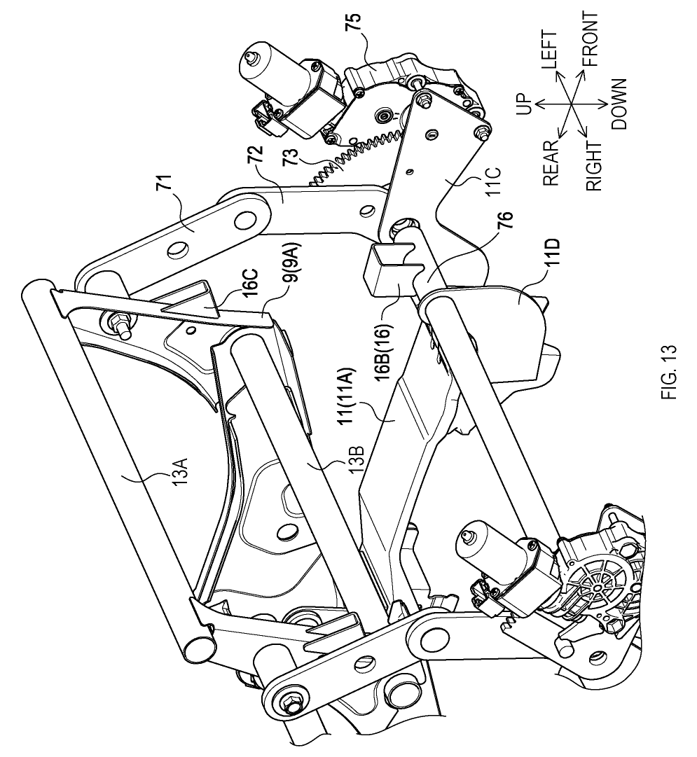

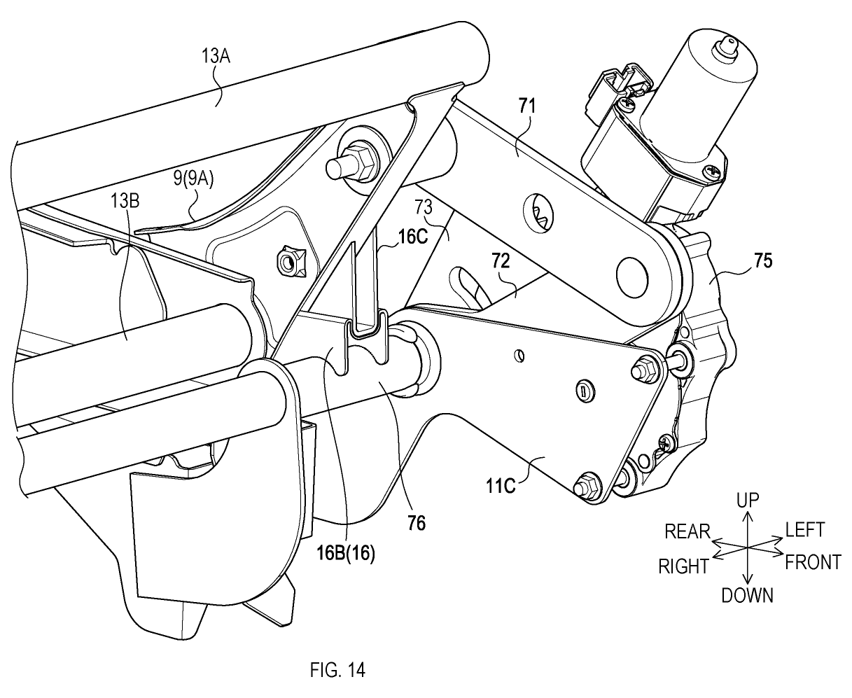

In the relaxation position, the EA portion 16B is located at a position where it can collide with the seat cushion 3 when the seat cushion 3 falls (see FIGS. 13 and 14). In the normal position, the EA portion 16B is disposed at a position deviated from the position where it can collide (see FIG. 12).

Specifically, in the relaxation position, the EA portion 16B is in a state of being convex upward (see FIGS. 13 and 14), and in the normal position, it is in a state of being convex forward (see FIG. 12). The EA portion 16B collides with an interference portion 16C provided on the side frame 9 (see FIG. 14).

The above description relates to the differences from the vehicle seat according to the above-described embodiment. Components identical to those in the above-described embodiment are denoted by the same reference numerals as in the above-described embodiment. Thus, in the present embodiment, redundant descriptions are omitted.

### Third Embodiment

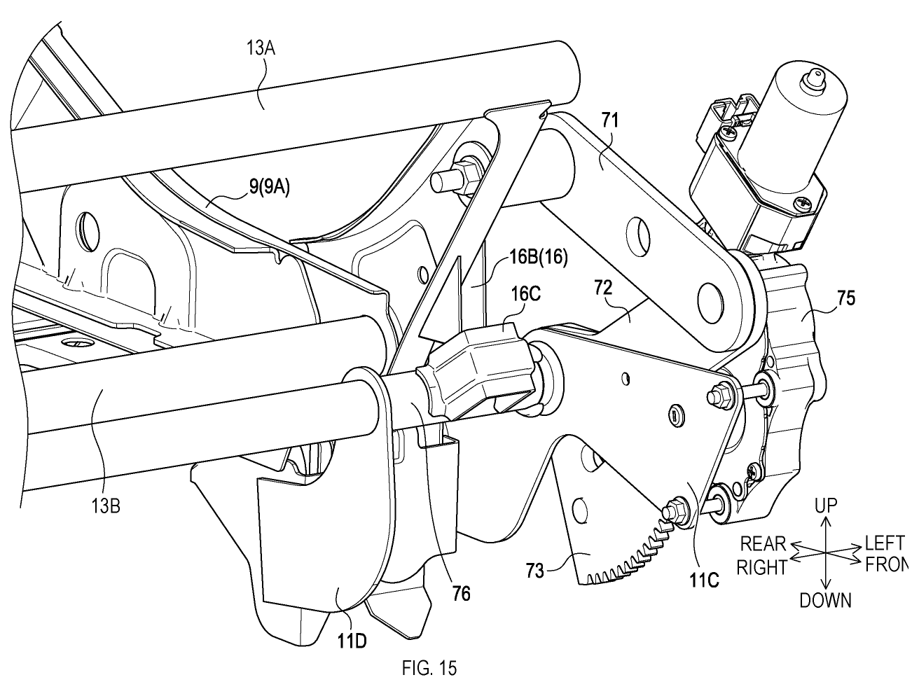

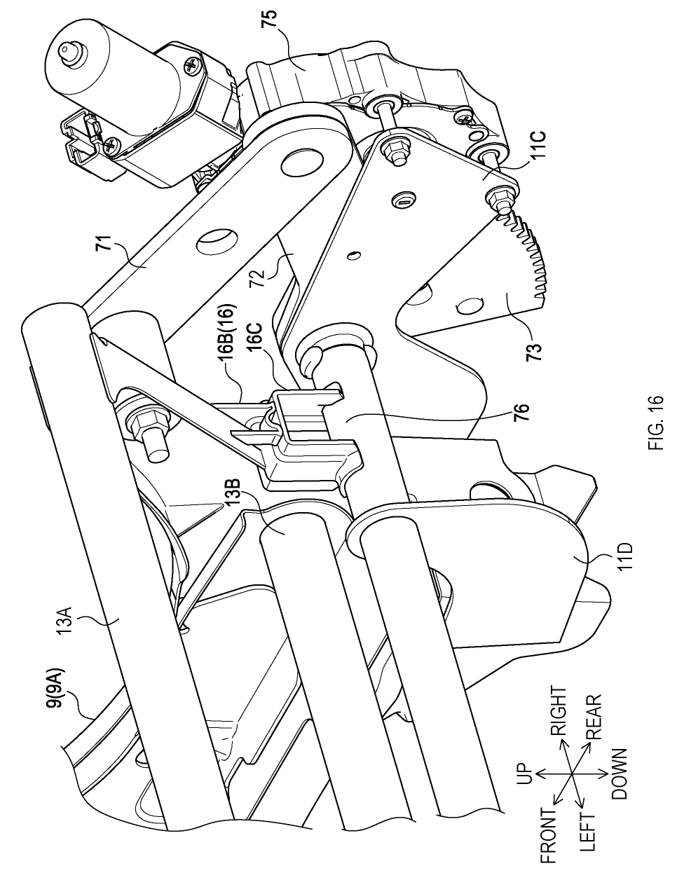

As shown in FIG. 15, in the present embodiment, the EA portion 16B is provided on the seat cushion 3, and the interference portion 16C is provided on the shaft portion 76. The interference portion 16C is disposed so as to collide with the EA portion 16B when the seat cushion 3 falls (see FIG. 16).

Specifically, in the relaxation position, the interference portion 16C is located at a position where it can collide with the EA portion 16B when the seat cushion 3 falls (see FIG. 16). In the normal position, the interference portion 16C is disposed at a position deviated from the position where it can collide (see FIG. 15).

The above description relates to the differences from the vehicle seats according to the above-described embodiments. Components identical to those in the above-described embodiments are denoted by the same reference numerals as in the above-described embodiments. Thus, in the present embodiment, redundant descriptions are omitted.

### Fourth Embodiment

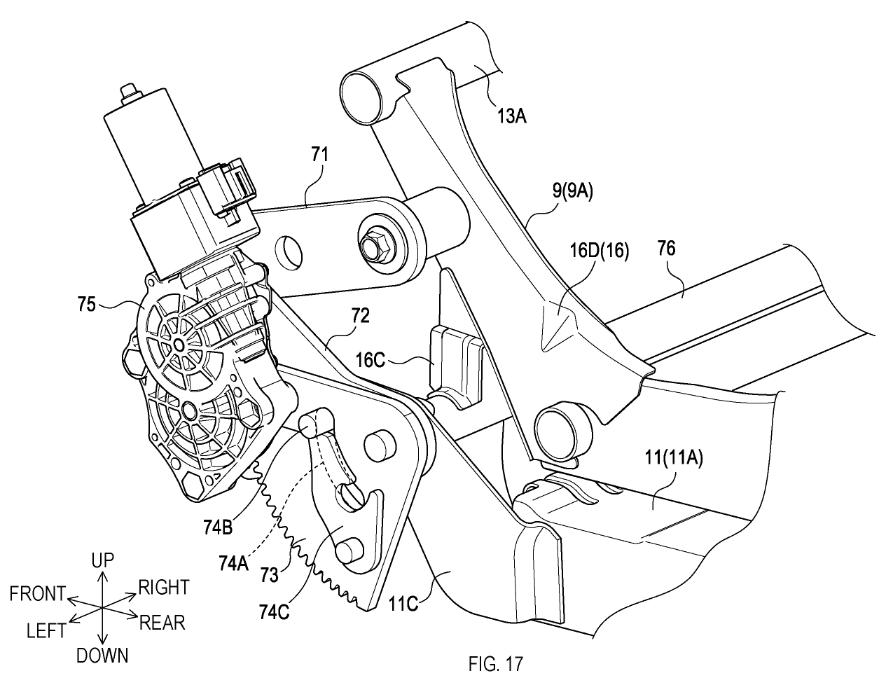

As shown in FIG. 17, the absorption portion 16 according to the present embodiment is formed by a fragile portion 16D. The fragile portion 16D is a part of the side frame 9 and has lower bending rigidity than other portions. Accordingly, the fragile portion 16D induces deformation of the seat cushion 3.

The interference portion 16C is the same as the interference portion 16C according to the third embodiment. That is, the interference portion 16C is disposed such that, in the relaxation position, it is at a position where it can collide with the seat cushion 3 (i.e., the side frame 9) when the seat cushion 3 falls, and in the normal position, it is at a position deviated from the position where it can collide.

When the side frame 9 collides with the interference portion 16C during the fall of the seat cushion 3, the fragile portion 16D plastically deforms earlier than other portions. Therefore, the kinetic energy is absorbed by the plastic deformation.

The above description relates to the differences from the vehicle seats according to the above-described embodiments. Components identical to those in the above-described embodiments are denoted by the same reference numerals as in the above-described embodiments. Thus, in the present embodiment, redundant descriptions are omitted.

### Fifth Embodiment

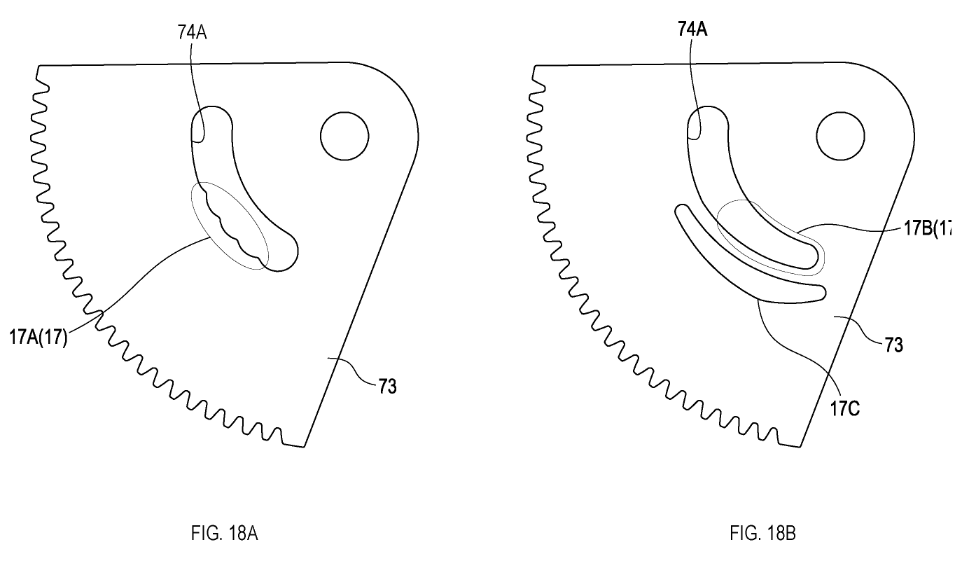

In the present embodiment, a resistance portion 17 shown in FIGS. 18A and 18B is provided in the elongated slot 74A. The resistance portion 17 is configured to resist displacement of the coupling pin 74B toward the lower end portion of the elongated slot 74A.

Specifically, the resistance portion 17A shown in FIG. 18A is formed by unevenness (i.e., projections and depressions) provided in the elongated slot 74A. That is, the minor diameter of the portion where the projection is provided is slightly smaller than the diameter of the coupling pin 74B. Thus, the resistance portion 17A resists the displacement of the coupling pin 74B toward the lower end portion of the elongated slot 74A.

The resistance portion 17B shown in FIG. 18B is configured such that the minor diameter of the elongated slot 74A becomes smaller than the diameter of the coupling pin 74B as it approaches the lower end portion of the elongated slot 74A. Accordingly, the resistance portion 17B resists the displacement of the coupling pin 74B toward the lower end portion of the elongated slot 74A.

In addition, the sector gear 73 is provided with a hole 17C for allowing the resistance portion 17B to deform such that the minor diameter of the elongated slot 74A expands. That is, when the coupling pin 74B is displaced toward the lower end portion of the elongated slot 74A, the resistance portion 17B plastically deforms, resulting in absorption of the kinetic energy.

In the present embodiment, the absorption portion 16 is eliminated. However, the absorption portion 16 may be provided. That is, a configuration in which the kinetic energy is absorbed by both the absorption portion 16 and the resistance portion 17B may be employed.

The above description relates to the differences from the vehicle seats according to the above-described embodiments. Components identical to those in the above-described embodiments are denoted by the same reference numerals as in the above-described embodiments. Thus, in the present embodiment, redundant descriptions are omitted.

### Other Embodiments

The coupling device 74 according to the above-described embodiments is configured such that the coupling between the second link 72 and the sector gear 73 is released by releasing the engagement between the coupling pin 74B and the locking member 74C. However, the present disclosure is not limited thereto.

That is, the present disclosure may have a configuration in which, for example, the locking member 74C is eliminated, a fracture-inducing portion such as a notch is provided in the coupling pin 74B, and the coupling pin 74B fractures at the fracture-inducing portion when an acceleration in the seat forward direction exceeding a predetermined magnitude occurs.

Alternatively, the present disclosure may have a configuration in which the second link 72 and the sector gear 73 are joined by soldering, brazing or the like, and the joint is shear-fractured when an acceleration in the seat forward direction exceeding a predetermined magnitude occurs.

Soldering/brazing is a method of joining using a filler metal having a lower melting point than base metal, such as “soldering” or “brazing”. In the above example, the second link 72 and the sector gear 73 correspond to the base metal.

In the above-described embodiments, the driving body is formed by the sector gear 73. However, the present disclosure is not limited thereto. That is, the driving body may be formed by, for example, a link member.

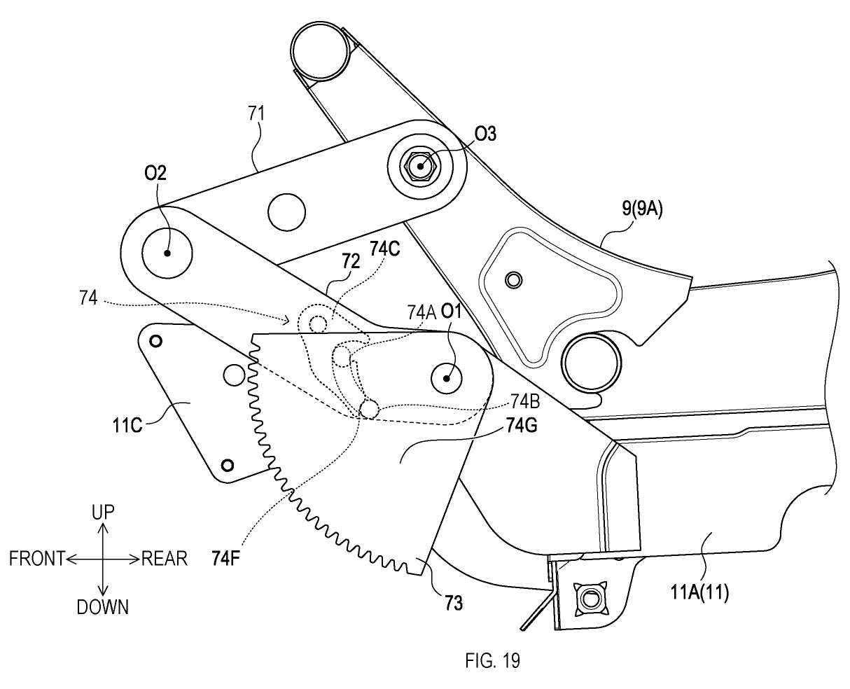

In the above-described embodiments, the coupling pin 74B is provided on the second link 72, and the elongated slot 74A and the locking member 74C are provided on the sector gear 73. However, the present disclosure is not limited thereto. That is, as illustrated in FIG. 19, the coupling pin 74B may be provided on the sector gear 73, and the elongated slot 74A and the locking member 74C may be provided on the second link 72.

The locking member 74C according to the above-described embodiments is configured to be disengaged from the coupling pin 74B by rotating forward. However, the present disclosure is not limited thereto. The locking member 74C may be configured to be disengaged from the coupling pin 74B by rotating rearward.

Specifically, if the position of the shaft 74E is provided on the opposite side of the position shown in FIG. 8 relative to the virtual line L2, and the inclination of the contact portion 74F is opposite to that shown in FIG. 8, the locking member 74C is disengaged from the coupling pin 74B by rotating rearward.

In the above-described embodiments, the absorption portion 16 and the restriction portion 74G are provided. However, the present disclosure is not limited thereto. For example, the absorption portion 16 and/or the restriction portion 74G may be eliminated.

In the above-described embodiments, the coupling center between the second link 72 and the fixed frame 11 coincides with the coupling center between the sector gear 73 and the fixed frame 11. However, the present disclosure is not limited thereto. For example, these two coupling centers may be shifted from each other.

In the above-described embodiments, the configuration is mainly such that the engagement between the locking member 74C and the coupling pin 74B is released using the inertial force generated in the second link 72 and the coupling pin 74B. However, the present disclosure is not limited thereto.

For example, a configuration in which the mass of the locking member 74C is increased to also utilize the inertial force acting on the locking member 74C to release the engagement between the locking member 74C and the coupling pin 74B may be employed.

The spring 74D according to the above-described embodiments is a torsion coil spring having a coiled portion disposed around the shaft 74E. However, the present disclosure is not limited thereto. The spring 74D may be, for example, a tension coil spring or a compression coil spring.

In the above-described embodiments, the vehicle seat according to the present disclosure is applied to the automobile. However, the application of the present disclosure is not limited thereto. That is, the present disclosure is also applicable to, for example, a seat used in vehicles, such as railroad vehicles, ships, or aircraft, and to a stationary seat used in theaters, at home, or in other places.

Furthermore, the present disclosure is not limited to the above-described embodiments as long as it conforms to the spirit of the disclosure described in the above-described embodiments. Therefore, a configuration in which at least two of the embodiments described above are combined, or a configuration in which any of the components illustrated or described with reference numerals in the above-described embodiments is eliminated, may be employed.

What is claimed is:

1. A vehicle seat comprising:
a fixed frame configured to be fixed to a vehicle;
a seat cushion comprising a front end portion and a rear end portion, the seat cushion being configured to be displaced between (i) a relaxation position in which the front end portion is at a higher position than the rear end portion and (ii) a normal position in which a height difference between the front end portion and the rear end portion is smaller than that in the relaxation position;
a first link comprising a first end portion and a second end portion, the first end portion being rotatably coupled to the front end portion of the seat cushion;
a second link comprising a third end portion and a fourth end portion, the third end portion being rotatably coupled to the second end portion of the first link, and the fourth end portion being rotatably coupled to the fixed frame;
a driving body rotatably coupled to the fixed frame and configured to rotate by receiving torque from an electric motor; and
a coupling device configured (i) to couple the second link with the driving body for the relaxation position and (ii) to release the coupling between the second link and the driving body in response to an acceleration in a seat forward direction exceeding a predetermined magnitude.

2. The vehicle seat according to claim 1, wherein:
the coupling device comprises a coupling pin, a locking member, and a spring;
one of the driving body and the second link is a first member;
the remaining one of the driving body and the second link is a second member;
the first member defines an elongated slot having a fifth end portion and a sixth end portion in a longitudinal direction of the elongated slot;
the second member is provided with the coupling pin passing through the elongated slot;
the locking member is provided on the first member so as to be displaceable between (i) an engagement position where the locking member is engaged with the coupling pin and (ii) a release position where the locking member is disengaged from the coupling pin;
the spring is configured to apply a biasing force to the locking member to hold the locking member in the engagement position; and
the driving body and the second link are configured to interlock with each other in a state where the coupling pin is positioned at the fifth end portion and is engaged with the locking member.

3. The vehicle seat according to claim 2, wherein:
when projected onto a virtual plane perpendicular to a seat width direction, a first coupling center, which is a coupling center between the fourth end portion of the second link and the fixed frame, coincides with a second coupling center, which is a coupling center between the driving body and the fixed frame;
the elongated slot is curved in an arcuate shape centered on the second coupling center;
a reference line is defined as a virtual line passing through the second coupling center and a center of the coupling pin in a state where the coupling pin is positioned at the fifth end portion of the elongated slot; and
when a contact portion is defined as a portion of the locking member that is in contact with the coupling pin in a state where the coupling pin is positioned at the fifth end portion of the elongated slot and the coupling pin is engaged with the locking member, the contact portion is inclined relative to the reference line and a virtual line perpendicular to the reference line.

4. The vehicle seat according to claim 2,
wherein the locking member comprises a rebound restriction portion configured to engage with the coupling pin positioned at the sixth end portion of the elongated slot to restrict the coupling pin from being displaced toward the fifth end portion.

5. The vehicle seat according to claim 1, further comprising
an absorption portion configured to absorb at least a part of kinetic energy of the seat cushion when the coupling between the second link and the driving body is released and the front end portion of the seat cushion falls.

6. The vehicle seat according to claim 5,
wherein the absorption portion is provided on the fixed frame.

7. The vehicle seat according to claim 5, wherein:
the absorption portion is configured to be displaced in interlock with the driving body; and
the absorption portion is provided so as to be (i) at a position capable of colliding with the seat cushion when the seat cushion falls during the relaxation position and (ii) at a position deviated from the position capable of colliding during the normal position.

8. The vehicle seat according to claim 5, wherein:
the absorption portion is provided on the seat cushion; and
the vehicle seat further comprises an interference portion configured to collide with the absorption portion when the seat cushion falls, the interference portion being arranged so as to be (i) at a position capable of colliding with the absorption portion when the seat cushion falls during the relaxation position and (ii) at a position deviated from the position capable of colliding during the normal position.

9. The vehicle seat according to claim 5, wherein:
the absorption portion is provided on the seat cushion as a weakened portion configured to induce deformation of the seat cushion; and
the vehicle seat further comprises an interference portion configured to collide with the seat cushion when the seat cushion falls, the interference portion being arranged so as to be (i) at a position capable of colliding with the seat cushion when the seat cushion falls during the relaxation position and (ii) at a position deviated from the position capable of colliding during the normal position.

10. The vehicle seat according to claim 2,
wherein the first member comprises a resistance portion configured to resist displacement of the coupling pin when the coupling pin is displaced toward the sixth end portion of the elongated slot.
